(19) United States
(12) Patent Application Publication
(10) Pub. No.: US 2004/0003735 A1
(43) Pub. Date: Jan. 8, 2004

(54) Method and apparatus for manufacturing of stamps from thermo-plastic micro porous material

(76) Inventor: Leo-Henn Humal, Tartu (EE)

Correspondence Address: Priit Humal, Suite L8272, 1455 Tallevast Road, Sarasota, FL, 34243-5036, US

(21) Appl. No.: 10/399,151

(22) PCT Filed: May 7, 2001
(86) PCT No.: PCT/EE01/00003

(30) Foreign Application Priority Data
Oct. 17, 2000 (EE) P200000408

(51) Int. Cl. B29C 43/02; B29C 43/22; B41F 23/04; B41N 6/00

(52) U.S. Cl. 101/401.1; 264/280; 264/322; 425/385; 101/487

(57) ABSTRACT

Method and apparatus for manufacturing of pre-inkable rubber stamps from micro porous thermo-plastic material (6) by use of thermal head (1), where material is compressed by not less than 0.5 mm and the controller switches on and off the heating elements (2) of the thermal head (1) in accordance with a pattern received from the computer, creating by melting the surface of the said material ink non-permeable elements, characterized in that the surface with the heating elements of the said thermal head has appropriate configuration that the stretching out of melted surface layer (5) of the said material under the elastic tension of the material (6) releasing from the compression by the thermal head (1) is avoided.

### TECHNICAL FIELD

The present invention belongs to the sphere of the technology of rubber stamp manufacturing, more specifically it offers a method that enables the final manufacturer to use industrially produced blank stamps, transferring to the blank stamps electronically prepared printing patterns. Said blank stamps comprise, as minimum, blank printing plate, cut to needed size, or, as preferred, blank printing plate fastened to the stamp mount.

### BACKGROUND OF THE ART

Instruments that can be connected to a computer to print-out the patterns, created in computer electronically, are widely used.

One known method in these instruments is the use of thermal head.

Thermal head is an electronic device that has several tiny heating elements that can be electronically switched on and off, using suitable controller. Sliding the thermal head over thermo sensitive paper, it is possible to create on this paper the pattern corresponding to the electrical signal that is sent to thermal head.

In the field of manufacturing pre-inkable rubber stamps micro porous thermo-plastic materials have been used, because their surface pores can be closed by heating and simultaneous compressing, in this way producing areas, which are impermeable to stamp ink, and can therefore serve as non printing elements of a rubber stamp's printing surface. A method for selective closing the surface pores of such materials by heating it by means of the light radiation is known (patent of the USA U.S. Pat. No. 5,858,298, B29C 67/20, L. H. Humal, 1999), where onto the surface of thermo-plastic micro porous material the original print-out pattern on transparent film is laid. Said material together with the print-out is pressed against the smooth transparent body and through the transparent body and film with original print-out a powerful light impulse is conducted, that melts and closes selectively the pores on the surface of the material. The same method can be used for pattern transfer to blank stamps (PCT application WO97/47471, B41D 7/00, L. H. Humal, 1997), where printing plate, mounted in the stamp mount, is pressed against the smooth transparent body by hydrostatic pressure applied to its rear side.

Stamp manufacturing process is known (Patent of the USA U.S. Pat. No. 5,741,459, B29C 59/02, Mitsubishi Pencil Co, 1998), and thermal head printer for thermoplastic material (PCT application WO99/30907, B41J2/32, Identity Group Inc 1999), where a sheet of thermoplastic material moves between thermal head and platen, and suitable controller controls thermal head. The method uses thermo-plastic material that is not mounted to the stamp mount. Such material is convenient to unwind from a reel and conduct to pass between the platen and the thermal head. Printing plate, mounted in the stamp mount, cannot be treated in that way.

Technical solution closest to the invention being described herein is method of production of planar stamp (Patent of the USA U.S. Pat. No. 5,845,573, B41C 1/14, Alps Electric Co and Tetsuyuki Toyama, 1998), where stamp mount together with blank printing plate from thermo-plastic micro porous material mounted in it is arranged into the apparatus, where thermal head slides over said printing plate, closing selectively its surface elements by selective heating with simultaneously compressing. To protect the surface of printing plate from immediate contact with thermal head, separating film is used, that is supplied from a suitable reel. It is described that the thermal head is pressed against the surface of printing plate, and that the thermal head and surface of printing plate form a line contact, but neither the force of pressing the thermal head against the printing plate surface, nor the depth of penetration of the thermal head into the printing plate's surface are specified.

In closing of pores of micro porous material by thermal head there are some problems not sufficiently solved up to here. As stated, the amount of pressure, applied to the thermoplastic porous material by thermal head, is not specified in patent of the USA U.S. Pat. No. 5,845,573 (Alps). According to the application WO97/47471 (Humal) for closing of pores by light radiation the pressure not less than 0.2 MPa is required. According to the patent of the USA U.S. Pat. No. 5,741,459 (Mitsubishi) the material that passes between thermal head and platen is compressed to 95 to 30 percent from its original thickness, whereas example is given where material of 1.6 mm is compressed by 30 percent. So, quite a large pressure has been applied and this is necessary indeed to have the pores closed totally. However, sliding of soft thermoplastic material in relation to thermal head, the material being simultaneously compressed, leads to following problems.

First, in spite of the fact that micro porous material is originally soft and elastic, that it can easily be deformed and that it recovers its original shape and properties after deformation, the ink non- permeable solid film that is created on its surface by heating and compression, has rather different properties: it is stiff and not very elastic, it gets permanent deformation (stretches out) after moderate stretching. As the created film is thin, the force necessary for it's stretching out is quite small. When the material compressed for processing by thermal head, releases from compression, then the elasticity of deeper layers of material stretches out the film created on the surface. The stretched film becomes creased and the folding points of creases will blot ink. It is not known that any attention has been paid to this problem and that any solution has been disclosed.

Second, soft material deforms not only perpendicular to its surface, but in the direction of movement of thermal head parallel to the surface too. This complicates the exact positioning of the pattern and can deform resulting pattern on the material. To avoid this, in the patent of the USA U.S. Pat. No. 5,845,573 (Alps) separating film is used, that must have sufficiently low friction coefficient to decrease the friction force arising from sliding of the thermal head. In application WO 99/30907 (Identity) some grease is used to favour the sliding of thermal head. As a matter of fact, it is difficult to find materials with such a low friction coefficient that only the decreasing of friction force should avoid the deformation in the direction of the moving of thermal head of the material being processed, if the simultaneous compression of the material is adequate for totally closing its pores.

For close description of these phenomena, let us look at the sliding of thermal head over the thermo-plastic micro porous material for thermal heads of known design.

The simplest to manufacture and the most greatly used are thermal heads, that have one line of heating elements, placed in a straight line on the side surface of thermal head (side type thermal head). The main purpose of these thermal heads is creation of print-outs on thermo sensitive paper, whereas the paper is pressed against the heating elements by a roller. It can be supposed that side type thermal head is used in the apparatus according to application WO 99/30907 (Identity) (FIG. 1a). When using thermal head 1 with heating elements 2 on its side surface, material 3 being pressed against it by roller 4 at the rear surface of the material 3, the surface of material that slides along the thermal head 1 flat side is not stretched by the elasticity of deeper layers releasing from compression, so the problem of permanent deformation of melted layer 5 is avoided, but it is not possible to use printing plates mounted in stamp mount it this apparatus.

Thermal heads are known that have heating elements on side surface, but very close to edge (near edge type thermal heads), and thermal heads with heating elements on edge (edge type thermal heads). Both these thermal heads can be used to reproduce printing patterns on thick, non-deformable material. In this case the purpose is to obtain contact with flat material on as small length as possible, and this characteristic can be used with thermoplastic materials too.

It seems that in process according to patent of the USA U.S. Pat. No. 5,741,459 (Mitsubishi) near edge type thermal head is used, and in method according to patent of the USA U.S. Pat. No. 5,845,573 (Alps) also near edge or edge type thermal head. Both near edge and edge type thermal heads usually have V-shaped profile with apex angle of 90 degrees and curvature radius of apex less than 0.2 mm. It is possible to compress micro porous thermo-plastic material locally by such thermal head to quite reasonable extent. For example, as said above, in the process according to patent of the USA U.S. Pat. No. 5,741,459 (Mitsubishi) material of 1.6 mm thickness was compressed by 30 percent.

On FIG. 1b relative movement of thermal head and material in process according to patent of the USA U.S. Pat. No. 5,741,459 (Mitsubishi) is sketched, where thermoplastic material 3 is deformed from both sides: by roller 4 from the rear side and by near edge type thermal head 1 from front side. On FIG. 1c the same is sketched for method of patent of the USA U.S. Pat. No. 5,845,573 (Alps), where printing plate 6 from micro porous thermo-plastic material is mounted into stamp mount 7, and is locally compressed by edge of thermal head 1 that is pressed against the surface of printing plate 6 by spring 8. In both situations, when the thermoplastic micro porous material 3 or printing plate made from this material passes heating elements 2 of thermal head 1, on the surface of material melted layer 5 is created. FIG. 1d demonstrates in a larger zoom, how melted surface layer is stretched out in region 9, and so surface layer 10, finally released from thermal head, becomes creased.

On FIG. 1e, If the deformation of the material in the direction of thermal head movement is sketched.

If, using method described in patent of the USA U.S. Pat. No. 5,845,573 (Alps), the compressing force of thermal head is chosen to be lighter than it is known to be necessary according to patent of the USA U.S. Pat. No. 5,741,459 (Mitsubishi) and application WO 97/47471 (Humal), it is not possible to have the pores on the surface to be closed totally and the non printing areas of printing plate will blot ink. But if compressing force is chosen that guarantees total closing of pores, the phenomena from surface deformation as described above will arise and again non-printing areas will blot ink, in this case in the break points of the creases.

Apparatus for manufacturing of rubber stamps by use of thermal head is known, where linear drive mechanism moves thermal head, so that it slides over the surface of stamp material (Japan Patent publication JP 4014477, B41K 3/36, Brother Ind. Ltd, 1992), where a different kind of material is used as compared to what is used in present invention.

The apparatus, closest to one according to present invention is described in above referred patent of the USA U.S. Pat. No. 5,875,573.

Thermal head developed particularly for manufacturing of rubber stamps from micro porous thermo-plastic material, is not described up to here. Special tools and appliances for fastening blank stamps and separating film with apparatus for manufacturing of stamps from micro porous thermoplastic material by use of thermal head are not described either. Blank stamps, supplied with tools for applying tension to separating film are not described as well.

### DISCLOSURE OF THE INVENTION

The main objective of the present invention is to find solutions to problems discussed above and to provide by that the method of manufacturing of high quality rubber stamps by use of thermal head whereas it shall be possible to transfer the typesetting pattern to printing plate mounted into the stamp mount. Other objectives of the present invention are to provide apparatus necessary for manufacturing of rubber stamps according to the proposed method, to provide thermal head for this method, to provide blank stamp, to provide tools for fastening separating film and for fastening blank stamp.

The main objective is achieved by use of thermal head of special design that avoids the creation of permanent deformation (stretching out) of the melted by thermal head surface layer of the stamp material under the elastic tension of material releasing from compression by thermal head.

As it was mentioned above, the stretching out of the melted surface layer is avoided when using side type thermal head, where the printing surface of the material is flat during the processing. So, one could consider that the solution is, as it is sketched on FIG. 2, a side type thermal head 1 with a line of heating elements 2. Printing plate 6, mounted in stamp mount 7, would slide along it, whereas the side surface thermal head is great enough to compress the printing plate 6 uniformly on whole its length. Unfortunately, the friction force that arises from sliding of large compressed surface is so high, that it is not possible to avoid deformation of material in the direction of thermal head movement in relation to the printing plate.

The solution according to the first embodiment is to use near edge or edge type thermal head, whereas the apex angle 11 (FIG. 3) of cross-sectional profile of the thermal head is at least 110 degrees, preferably 140 . . . 150 degrees. When using thermal head with described profile, the melted surface 5 of compressed thermo-plastic micro porous material releases from the pressure gradually, sliding along the incline 12, so its melted surface layer is not stretched out to an extent that it would have deep creases with breaking points that would blot ink. At the same time, the heavily compressed surface area is not too large and we have a solution, described next, to avoid the deformation of surface of material in the direction of thermal head movement.

In the first embodiment of the invention, the solution of the problem of deformation of stamp material in the direction of movement of thermal head is using of the separating film between thermal head and stamp material, fastened in a way, that friction force of sliding the thermal head along the surface of stamp material is responded by said separating film and not stamp material. This is achieved by fastening of separating film 13 . . . 15 (FIG. 4) from that end, where the sliding of thermal head over the printing plate 6 starts (front end) stiffly. This kind of fastening creates in the part 14 of separating film that lies between fastening tool and the thermal head 1 tension that balances the friction force of sliding of thermal head 1 along the film. Further, as the part 14 of film will lengthen by certain extent under that tension, longitudinal and transverse waves can arise in the part 15 of separating film that lies in the direction of movement of thermal head (rear end). To avoid this, the part 15 of separating film is fastened by elastic appliance that holds this part of film under tension too.

In the second embodiment of the invention, the solution of the both problems is using of thermal head, that has its heating elements placed as two-dimensional matrix and is capable of processing by selective heating the whole printing surface of the blank printing plate without moving in relation to it (FIG. 5), similarly as it is done when selectively heating the surface be light energy as it is described in patent of the USA U.S. Pat. No. 5,858,298 (Humal).

Special apparatus is necessary for accomplishment of the disclosed method. According to present invention, the apparatus comprises case, thermal head, controller with memory device and interface for connecting to computer and tool for fastening of blank stamp, whereas thermal head compresses the surface to be processed by selective heating to a minimum of 0.5 mm and the design of the thermal head and the mode of compression of the surface are chosen in a way that stretching out of the melted surface layer of processed material under the elastic tension of the deeper layers of material is avoided.

In the apparatus for the first embodiment of the invention thermal head with heating elements in one line is used and it or the blank stamp is moved by drive mechanism in a way that thermal head slides over the surface of blank stamp, compressing it simultaneously by at least 0.5 mm, whereas the surface with the heating elements of the thermal head has appropriate configuration that avoids stretching out of the melted surface layer of processed material under the elastic tension of the deeper layers of material. More exactly the shape of thermal head that agree with the requirements is chosen as near edge or edge type thermal head with V-shaped cross section, that has apex angle not less than 110 degrees and sides of V not less than 1.5 mm. While thermal heads with required configuration are not needed for other purposes and are not in production as standard components, the solution is disclosed where in the said apparatus an inclined tool 16 (FIG. 6) is used that together with surface with heating elements 2 of thermal head 1 creates V-shaped cross section with apex angle not less than 110 degrees.

In the apparatus for the second embodiment thermal head is used that has heating elements placed as two-dimensional matrix that processes the surface of stamp material without moving in relation to it. The two-dimensional thermal head comprises flat substrate, the first set of parallel electrodes on it, the second set of parallel electrodes, perpendicular to the said first set, and heating elements from semiconductor material between the first and second electrodes in the crossing points of the electrodes, whereas said electrodes are connected to electronic circuit that is controlled by external controller that creates in said heating elements current impulses that heat the elements selectively, creating melted areas in the thermoplastic micro porous material that is pressed against the surface of the thermal head.

Further solutions are disclosed in relevance of apparatus for the first embodiment that makes the apparatus simpler in design and more convenient in use. As drive mechanism that performers the sliding of thermal head over the surface of blank printing plate, a linear mechanism 17 (FIG. 7) is used, that moves said thermal head 1 in the way, that the surface with heating elements of it slides over printing plate 6, whereas the blank stamp is fastened immovably in relation to case 19 by use of appropriate tool 18. As it is necessary to have the linear mechanism moving not only in the direction where the printing plate is processed by the thermal head, but back to the staring position too, the solution is described, where the rear end of linear mechanism 17 is fastened in the case 19 by horizontal arbor 20, that enables the linear mechanism 17 together with its working shaft 21 extending from its front side and thermal head 1 fastened on it to rotate in the vertical plane, and the case 19 has two sets of guides that enable the thermal head to move along the case's longitudinal axis on two different heights.

For the first embodiment of the invention, tools and appliances are disclosed that perform the fastening of separating film between thermal head and blank stamp that unloads the blank stamp from friction tension of sliding thermal head. When blank stamp consisting of stamp mount 7 (FIG. 4) with mounted printing plate 6 is used, use of fastening tool is disclosed that has the said separating film stored on a reel 25, whereas the said tool is provided with locker 34 to fasten the free end 13, 14 of the said separating film, the said reel 25 is placed in the direction where the thermal head moves when performing the processing of the surface of the said material (the rear direction) and the said locker 34 is placed in the direction where the said thermal head starts its movement (the front direction), and friction element is used that prevents free rotation of the said roller and unwinding of the said separating film, and stretcher 80 with elastic element 28 is used that holds the part 15 of the said separating film between the thermal head and reel under tension. When blank stamp consisting only of printing plate 6 (FIG. 9), cut to appropriate dimensions, is used, disposable fastening appliances are disclosed characterized in that when placed into the tool for fastening of blank stamp into the apparatus for manufacturing of the stamps by use of thermal head, the said tool fastens stiffly that end of the said separating film where the sliding of the thermal head over the surface of the blank stamp starts (front end), whereas in the opposite end (rear end) elastic tension is created and the said elastic tension of the said separating film and its fastening elements when the blank stamp is placed in the said tool is higher than the elastic tension of the same elements when lying freely or packed. Such arrangement avoids creep and relaxation of the disposable elastic element.

### DESCRIPTION OF DRAWINGS

FIGS. 1 (a-f)—deformation of stamp material by prior art thermal heads

FIG. 2—unrealistic solution of use of side type thermal head

FIG. 3—use of thermal head according to the first embodiment

FIG. 4—tool for fastening of blank stamp and separating film for the first embodiment

FIG. 5—use of two-dimensional thermal head according to the second embodiment

FIG. 6—modification of standard thermal head for the first embodiment

FIG. 7—apparatus for manufacturing of rubber stamps according to the first embodiment

FIG. 8—tool for fastening of blank stamp with disposable separating film and fastening appliances

FIG. 9—blank stamp with disposable appliances

FIG. 10—thermal head of special design for the first embodiment

FIG. 11—electrical circuit diagram for thermal head of the second embodiment

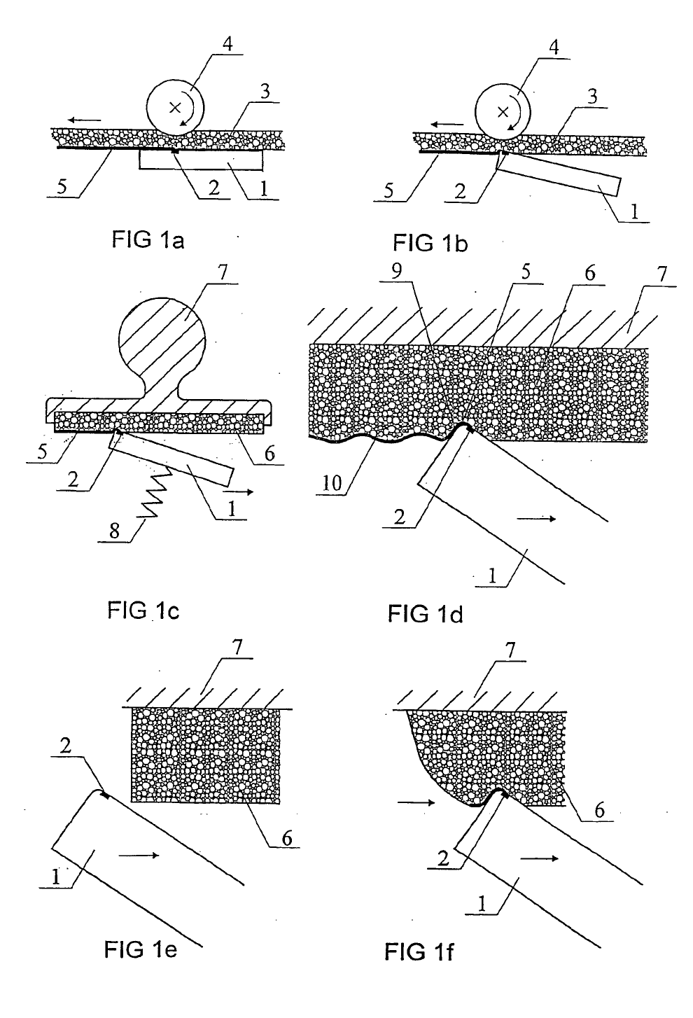

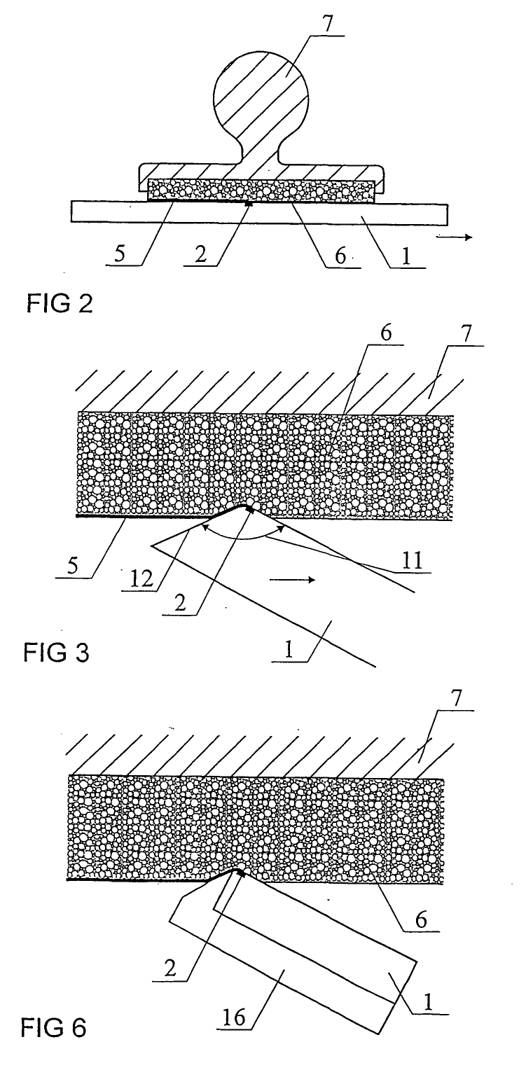

### DESCRIPTION OF THE PREFERRED EMBODIMENTS

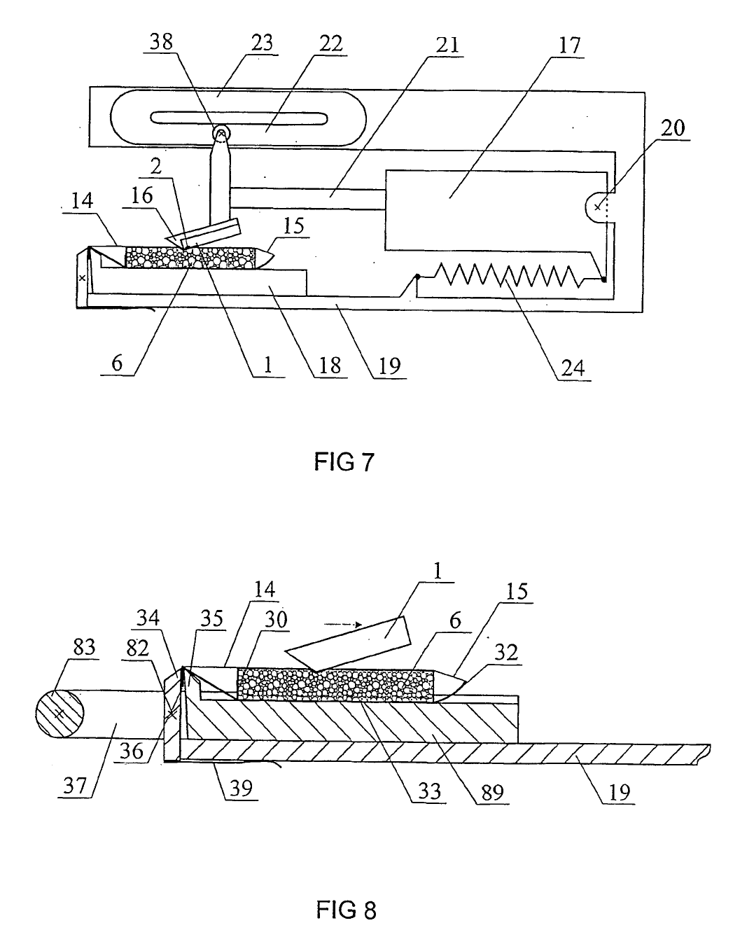

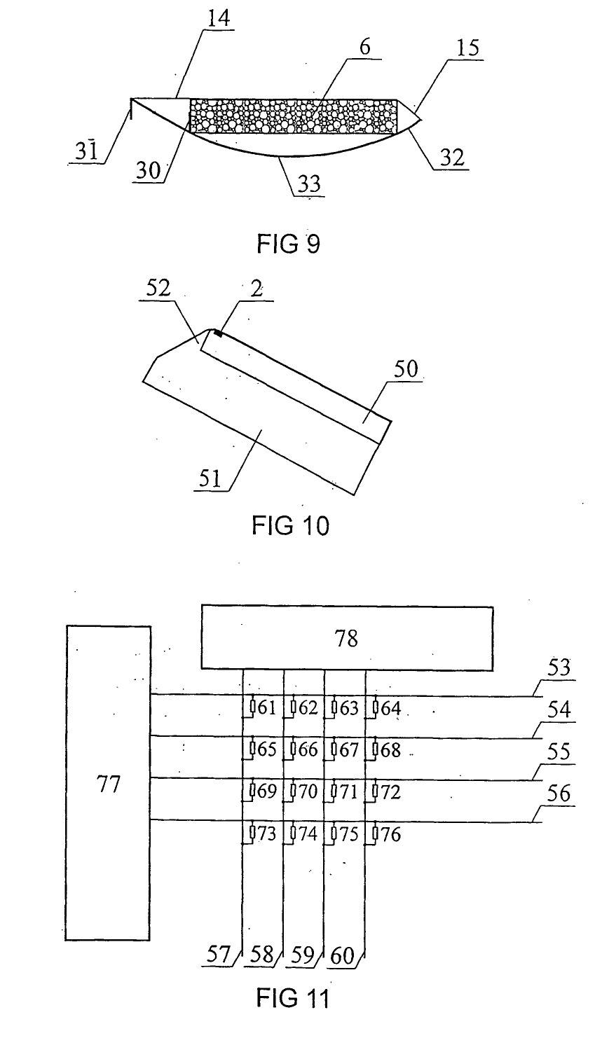

The apparatus is used to accomplish the first embodiment of the invention (FIG. 7), that comprises of case 19, fastened in it by horizontal arbor 20 linear mechanism 17, spring 24 that applies rotating moment on linear mechanism 17 over the arbor 20, connected to working shaft 21 of linear mechanism 17 thermal head 1 and controller (not shown on the figure), connected to computer. Inclined tool 16 is applied to thermal head 1 that creates V-shaped cross section to the thermal head with apex angle not less than 110 degrees. Case 19 has lower guides 22 and upper guides 23 that support rollers 38 that are in connection with thermal head 1. Blank stamp, consisting of piece of stamp material 6, separating film 14, 15 and disposable appliance 30 . . . 33 for fastening (FIG. 9) is shown, and tool 18 for fastening of blank stamp and separating film according to FIG. 8, that can be inserted into the case 19 of apparatus. The tool 18 (FIG. 8) has on its front side slot 36 between locker 34 and protruding edge 35, this slot 36 serving for fastening of front end of separating film 14. The rear end of appliance has elastic part 32 that holds the rear part 15 of separating film under tension. Locker 34 has a flexible lever 39 that is supported by case 19 when the tool is inserted into the apparatus and forces the locker 34 to close the slot 36.

The apparatus functions as following. Under the command from controller linear mechanism 17 (FIG. 7) pulls its working shaft 21, moving the thermal head 1 to backmost position. Rollers 38 are released from lower guides 22 and the tension of spring 24 lifts the linear mechanism together with the thermal head 1 to the upper guides 23. The operator pulls the tool 18 out of the apparatus, places on it blank stamp, consisting of printing plate 6 and appliance 30 . . . 33, arranging the front part 31 of the appliance together with front end 14 of separating film in the slot between locker 34 and edge 35. After that, the blank stamp is pushed down to the baseboard of tool 18, so that part 33 of the appliance becomes flattened and locates tightly between sidebars 37 of tool 18. During this part 32 is bent to relatively small radius and will act as an elastic element that creates tension in the rear part 14 of separating film. Following, the operator inserts the tool 18 back into the apparatus, lever 39 will be supported by lower surface of case 19 and the locker 34 presses the part 31 of appliance to edge 35, fastening it stiffly. Following, the computer that is connected to the controller is given the command to send to the controller the pattern to be transferred to stamp. Having received the pattern, controller gives the linear mechanism 17 the command to push the working shaft 21 outward. Now the thermal head 1 moves forward, above blank stamp 6 and separating film 14, 15 without contacting with them, until the rollers 38 will release from guides 23 and sink down under the weight of thermal head 1 and linear mechanism 17, up to the lower guides 22. After that, the controller gives to the linear mechanism 17 the command to pull its working shaft 21 inward. Thermal head 1 will move backward, lower guides 22 guide the rollers 38 and the thermal head will slide over the surface of printing plate 6 of blank stamp. The height of thermal head's V-shaped apex above the baseboard of the tool 18 is chosen to be adequate to compress the printing plate to not less than by 0.5 mm. Simultaneously controller, according to bit-map pattern, sent from the computer, switches selectively on and off the heating elements 2 of thermal head 1, and line after line all the pattern is transferred to the surface of micro porous material as melted and non melted elements. When the thermal head 1 slides over the printing plate 6 from front to backward, the front part 14 of separating film, fastened between the locker 34 and edge 35, responds to the friction force of sliding the thermal head 1 and avoids deformation of printing plate 6 in the direction of movement of the thermal head. Bent rear part 32 of appliance holds the rear end 15 of separating film under tension too and avoids creation of waves in it. The linear mechanism 17 pulls its working shaft 21, until the rollers 38 will release from guides 22 and thermal head 1 lifts to the upper position. Operator pulls out the tool 18 together with the printing plate 6, and separates the printing plate 6 with pattern created on it from the separating film 14, 15 and appliance 30 . . . 33.

The apparatus to accomplish the second embodiment of the invention (FIG. 5) comprises of case 40, with two-dimensional thermal head 41 fastened into it, connected with the case by hinge 42 lid 43 and pressing mechanism. The bottom surfaces 44 of lid has configuration that enables to press the printing plate 6, mounted in stamp mount 7, against the surface with heating elements 2 of thermal head 41. The pressing mechanism comprises of eccentric 45 that rotates together with handle 46. On the eccentric 45 tractor 47 is adjusted, that has hook 48, that can latch with cradle 49 of case 40. Apparatus has the controller (not shown on the figure), connected to the computer, where the bit-map pattern to be transferred to the blank stamp is prepared.

The apparatus functions as following. The computer that is connected to the controller is given the command to send to the controller the pattern to be transferred to stamp. After that, by handle 46 the hook is released, the lid 43 is opened, rotating it around the hinge 42 up to vertical position. Onto the surface of the thermal head blank stamp, comprising of stamp mount 7 with printing plate 6 is laid. Now the lid is closed, hook 48 is arranged to latch with cradle 49, and the handle 46 is turned to force the eccentric 45 to pull through tractor 47, hook 48 and cradle 49 the lid 43 downward, compressing printing plate 6, contacting with the thermal head 41. Moving of the handle 46 closes a contact (not shown on the figure) that gives the controller (not shown on the figure) command to start transfer of pattern to printing plate. Controller switches on and off selectively, according to bit-map pattern received from computer, the heating elements 2 of the thermal head 41, until all the pattern is transferred onto the surface of micro porous printing plate as melted and non-melted elements. After that, controller indicates with appropriate indicating element (not shown on the figure) that the pattern is ready and operator releases again by handle 46 the hook 48, opens the lid and takes out the stamp mount 7 together with printing plate 6 where the pattern has been transferred.

For the first embodiment of the invention, use of near edge or edge type thermal head is necessary, where the apex angle 11 (FIG. 3) is not less than 110 degrees, preferably 150 . . . 160 degrees. Thermal head, specially designed for this purpose, consists of ceramic substrate 50 (FIG. 10), heating elements 2 on it and switching elements (not shown on the figure) similar to known thermal heads with heating elements in line, but metal part 51 that supports the said ceramic substrate 50 has a protruding edge 52, that together with the surface of the ceramic substrate creates necessary V-shaped cross section.

For the second embodiment of the invention, use of two-dimensional thermal head is necessary. Two-dimensional thermal head 41 (FIG. 5) comprises of a flat substrate, the first set of parallel electrodes on it, the second set of parallel electrodes perpendicular to the first set, and heating elements from semiconductor material between the first and the second electrodes in the crossing points of the electrodes, whereas said electrodes are connected to electronic circuit that is controlled by external controller that creates in said heating elements current impulses that heat the elements selectively, creating melted areas in the thermo-plastic micro porous material that is pressed against the surface of the thermal head.

The circuit diagram of the two-dimensional thermal head is shown on the FIG. 11. The first set of parallel electrodes is shown as horizontal wires 53 . . . 56, the second set as vertical wires 57 . . . 60, and heating elements from semiconductor material are shown as resistors 61 . . . 76. To illustrate the principle of its operation, on the figure only four horizontal and vertical wires are shown, actually there are much more, hundreds or thousands of electrodes. As an example is described thermal head of length of 4 and width of 2 inches, where for resolution 300 lines per inch are used 1200 horizontal and 600 vertical electrodes. As semiconductor material zinc oxide ZnO doped with other metal oxides is used, in the result the heating elements 61 . . . 76 from semiconductor material in the crossings points of the electrodes comprise non-linear resistors known in the technology as varistors. Each varistor has dimensions 40 by 40 micrometers, thickness of 20 micrometers. Known method of produce the thick-film varistors is used, described, for example, in the patent of the USA U.S. Pat. No. 4,460,624. The composition and processing parameters of semiconductor material are chosen to have in the varistors of given dimensions at the voltage of 48V the current of about 5 mA.

The first set of parallel electrodes 53 . . . 56 is connected to row drivers 77 and the second set of parallel electrodes is connected to the column drivers 78. Row drivers consist of bipolar transistor of p-n-p type, each wire 53 . . . 56 is connected to the collector of one of the transistors, whereas the transistors are connected to appropriate logical circuit that enables under the control of external controller (not shown on the figure) to select one of the said transistors that is opened and its collector receives the voltage practically equal to the voltage of positive output of power supply (not shown on the figure).

The column drivers 78 are similar to drivers known as used in the thermal head with heating elements in line, consisting of bipolar transistors of n-p-n type, each wire 57 . . . 60 is connected to the collector of one of the transistors, whereas the transistors are connected to the appropriate logical circuit that enables the external controller (no shown on the figure) to select any combination of the transistors to be opened and their collectors receives the voltage practically equal to the negative output of the power supply (not shown on the figure). The row drivers are supplied by +48 volts. As simultaneously can be switched on one of the row drivers and several column drivers, and the current of all the switched columns flows through this only row driver, the known miniature transistors in SOT-323 case are used as the row drivers that are capable of switching 0.6A at 50V (Zetex ZUMT2907A). Said horizontal electrodes are grouped by twelve consecutive to be connected to row drivers on one side of matrix, and then twelve consecutive to the row drivers on the other side of the matrix. There are 50 groups to be connected to the row drivers of both the sides and as a result 50×12=600 transistors as row driver are used in both the sides, in total 1200 transistors for the 1200 rows. The transistors on each side form matrixes 50 by 12 where the emitters of transistors are connected together along the columns and bases along the rows, and from the row and column wires connections are made to drivers and logical circuits of conventional technology. As column drivers of the two-dimensional thermal head integral transistors are used on common chip with logical circuit for switching them on and off, 64 transistors on each chip. Each column driver is capable of switching current up to 10 mA at the voltage of 50V.

The described thermal head functions as following.

The controller switches on the first row driver that drives the first horizontal electrode to +48V, and selected column drivers, that drive the selected vertical electrodes to 0 V. The varistors in the crossing points of each selected vertical electrode and the first horizontal electrode get the current of about 5 mA that applies to them power of about 240 mW. During 0.5 to 1 ms in the selected varistor energy is dissipated that creates on the surface of the thermal head heated region, where in the radius of 60 . . . 80 micrometers the temperature is increased by about a 100 centigrade. As the row drivers are rated to 600 mA, all the column drivers must not be selected simultaneously, but exposition of the row is performed by, at least, 5-6 parts. The controller selects consecutively the row drivers and column drivers corresponding to the pattern to be created, performing gradually the exposition of the necessary pattern. Totally the exposition of the each row takes about 3 to 6 ms, the exposition of the all 1200 rows 4 to 8 seconds.

Simultaneously with the varistors in the selected rows the varistors of the all other rows get part of the applied voltage, because part of the column drivers are switched on, the other part are switched off. For example, let the row 53 (FIG. 11) be selected, the columns 57, 58 and 59 selected, but the column 60 unselected. Varistors 61, 62 and 63 get the total voltage and are heated as required. At the same time parasitic current path exist from the row 53 through varistor 64 to column 60, further through varistors 68,72 and 76 to all unselected rows and from them through varistors 67, 71 and 75 to column 59, through varistors 66, 70 and 74 to column 58 and through varistors 65,69 and 73 to column 57. If not varistor but linear resistor were used, the power dissipated in the element 64 would be almost the same as in selected elements 61, 62 and 63. But due to non-linearity of the varistor the power dissipated in the parasitic current paths is negligible.

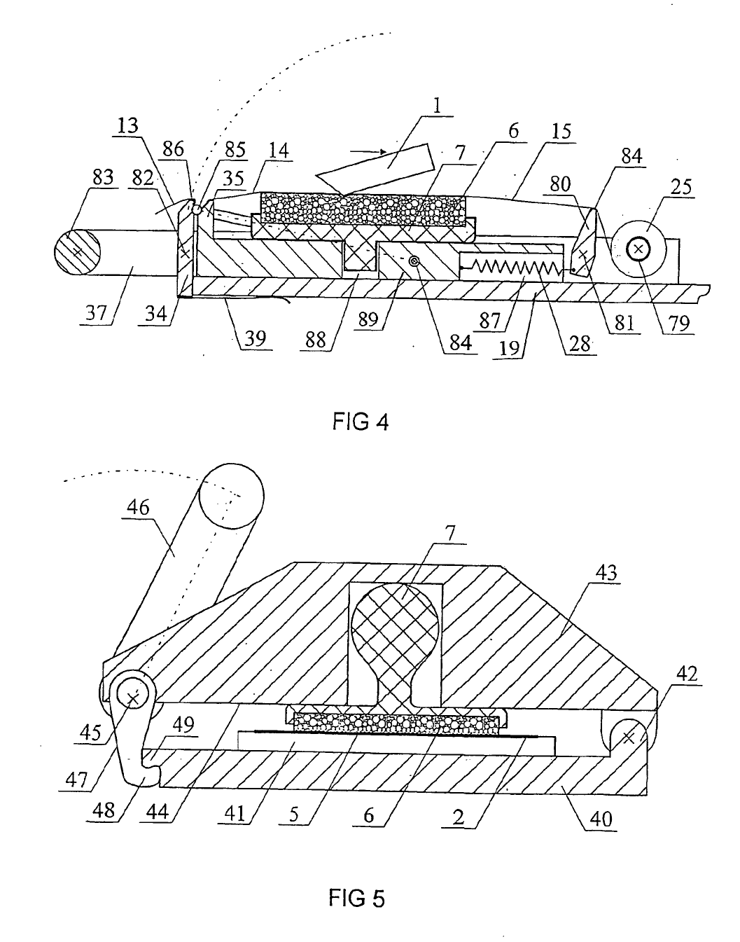

For the first embodiment of the invention, tools and appliances are necessary that perform the fastening of separating film between thermal head and blank stamp that unloads the blank stamp from friction tension of sliding thermal head. When blank stamp consisting of stamp mount 7 (FIG. 4) with mounted printing plate 6 is used, the fastening tool is used consisting of baseboard 89 with sidebars 37. In the rear part of sidebars 37 there are slots, where the ends of core 79 of the reel 25 can rotate, but free rotation is restricted by a friction element (not shown on the figure). There are also gaps in the sidebars 37 for pin 81 of stretcher 80 and pin 82 of locker 34. There is a handle 83 connecting the front sides of the sidebars. The tool is supplied with a rectangular frame, the rear side 84 of which is located in the gap drilled through the base board 89 and sidebars 37 so that it forms an axel that the frame can be rotated around. When the said frame is brought to the forward position, the front side 85 of the frame locates between the locker 34 and the protruding edge 35, fitting with the groove 86 of the locker 34.

The locker has a flexible lever 39 that is supported by case 19 when the tool is inserted into the apparatus and that forces the locker 34 against the side 85 of the said frame. In the baseboard 18 there is spring 28 in the groove 87 that makes the stretcher 80 to rotate around its pin 81 moving its edge 84 backwards. In the baseboard there is an opening 88 for fastening of the blank stamp 6.

The tool functions as following. By pulling the handle 83 the tool is removed from the stamp manufacturing apparatus. A blank stamp is placed on the baseboard 18, fitting its rear side in the opening 88. The frame is turned around the axes to vertical position. The separating film 13 . . . 15 is pulled off the reel to an extent that the free end of the film 13 would reach over the locker 34 and then the frame is turned forward, the front side of the frame 85 presses the separating film in between the locker 34 and edge 35. At the same time the free end of the separating film 13 is pulled in a way that the stretcher 80 remains in its forward position. Next, the tool is inserted into the stamp manufacturing apparatus. The flexible lever 39 presses the locker 34 against the side 85 of frame, fastening by that the free end of the separating film around the side 85 of the frame. The groove 86 in the locker does not allow the side 85 of the frame to rise up. When the thermal head 1 slides along the surface of printing plate from front to back, separating film 13 . . . 15 fastened by the locker 34 responds to the created friction force and prevents the deformation of printing plate 6 in the direction of the thermal head movement. The stretcher 80 holds the rear end 15 of the separating film under tension, too, and prevents creation of waves.

When blank stamp consisting only of printing plate 6 (FIG. 9), cut to appropriate dimensions, is used, it has disposable separating film 13, 14 and fastening appliance 30 . . . 33. The appliance 30 . . . 33 is made of light cardboard. The appliance has section 30 that is used to glue it to the printing plate, section 31 to which the front end of the separating film is glued, section 32 to which the rear end of the separating film is glued and section 33 that connects the front and the rear ends of the separating film. The length of section 33 is selected so that it forms an arch of low curvature due to the tension of the separating film. Appliance 30 . . . 33 width is selected so that it fits tightly in between the sidebars 37 of the tool (FIG. 8).

The tool (FIG. 8) consists of a baseboard 89 with sidebars 37. There are gaps in the sidebars 37 for the pins 82 of the locker 34. There is a handle 83 connecting the front ends of the sidebars. The locker has a flexible lever 39 that is supported by case 19 when the tool is inserted into the apparatus and that forces the locker 34 against protruding edge 35.

The functioning of the tool and appliance is already described with the description of the apparatus according to the first embodiment.

Disclosed method, apparatus, thermal head, tool and appliance enable to manufacture pre-inkable rubber stamps of high quality, directly from the typesetting created in a computer. Part of the operations of manufacture (cutting out the printing plates, mounting of the printing plates to stamp mounts) can be done previously, consequently they can be performed industrially, providing the stamp manufacturers with blank stamps that makes the final manufacturing even more easy.

1. Method for manufacturing of pre-inkable rubber stamps from micro porous thermoplastic material consisting of selective closing of the surface pores of the said material by selective heating, where the selective heating is performed by thermal head and the selectively heated surface of the said material is simultaneously compressed by the said thermal head by not less than 0.5 mm, and the side of the said material opposite to the surface selectively heated and compressed by the said thermal head is supported by a flat body, characterized in that the surface with the heating elements of the said thermal head has appropriate configuration that the creation of residual deformation in the melted surface layer of the said material under the elastic tension of the material releasing from the compression by the thermal head is avoided.

2. Method as claimed in claim 1, characterized in that thermal head with heating elements in one line is used that slides over the surface of the said material simultaneously compressing it, where the said thermal head has V-shaped cross section with the apex angle of V not less than 110 degrees and sides of V not less than 1.5 mm.

3. Method as claimed in claim 1, characterized in that two-dimensional thermal head is used, pressed with its surface with heating elements against the surface of the said material, where the said two-dimensional thermal head performs the processing of the surface of the said material by selectively heating its surface elements without moving in relation to the said material.

4. Method as claimed in claim 2, characterized in that the surface of the said material is protected from the immediate contact with the said thermal head by a separating film, whereas that end of the said separating film, from where the movement of the said thermal head over the said material starts (front end of separating film) is fastened stiffly, and the opposite end of the said separating film, that lies in the direction of the movement of the said thermal head (rear end) is fastened by an elastic appliance that holds the rear end of the said separating film under tension when the said thermal head slides over the said material.

5. Apparatus for manufacturing of pre-inkable rubber stamps from micro porous thermoplastic material, consisting of a case, a thermal head, a controller that includes a memory device and interface for connecting to the computer, and a tool for fastening of blank stamp, where the thermal head compresses the said material by not less than 0.5 mm and the said controller switches on and off the heating elements of the thermal head in accordance to a pattern received from the said computer, creating on the surface of the said material by melting it ink non-permeable elements, characterized in that the surface with the heating elements of the said thermal head has appropriate configuration so that the creation of residual deformation in the melted surface layer of the said material under the elastic tension of the material releasing from the compression by the thermal head is avoided.

6. Apparatus as claimed in claim 5, characterized in that thermal head with heating elements in one line and appropriate moving mechanism are used, where the said moving mechanism performs the movement of the said thermal head or the said blank stamp, so that the said thermal head slides over the surface of the said material simultaneously compressing it, where the said thermal head has V-shaped cross section with the apex angle of V not less than 110 degrees and sides of V not less than 1.5 mm.

7. Apparatus as claimed in claim 5, characterized in that two-dimensional thermal head is used, pressed with its surface with heating elements against the surface of the said material, where the said two-dimensional thermal head performs the processing of the surface of the said material by selectively heating its surface elements without moving in relation to the said material.

8. Apparatus as claimed in claim 6, characterized in that the said moving mechanism is linear mechanism, that performs the movement of the said thermal head, where the said blank stamp is fastened steadily in the case of apparatus and the rear end of the said linear mechanism is fastened in the case of apparatus by a horizontal arbor, that enables the linear mechanism together with its working shaft and the said thermal head to rotate in the vertical plane, and the case of apparatus is provided with to sets of guides that enable the said thermal head to move along the said case on two different heights.

9. Apparatus as claimed in claim 8, characterized in that a spring is used that has tension moment in relation to the said arbor that balances the weight of said linear mechanism, the thermal head and other parts moving together with the thermal head to the extent, that when the thermal head is in its backmost position, the tension of spring lifts the linear mechanism together with the thermal head up to the upper guides, that will guide the movement of the thermal head on its forward movement, and when the thermal head is in foremost position, then the moment of the weight of thermal head and moving together with it parts in relation to said arbor exceeds the moment of tension of the said spring and the thermal head sinks down to the lower guides.

10. Two-dimensional thermal head comprising of flat substrate, the first set of parallel electrodes on it, of the second set of parallel electrodes, perpendicular to the said first set, and heating elements from semiconductor material between the first and second electrodes in the crossing points of the electrodes, whereas said electrodes are connected to electronic circuit that is controlled by external controller, that creates in said heating elements current impulses, that heat the elements selectively, creating melted areas in the thermoplastic micro porous material that is pressed against the surface of the thermal head.

11. Tool for fastening of separating film for the manufacturing of rubber stamps from thermoplastic micro porous material, where the said thermal head slides along the said material simultaneously compressing the said material and where the surface of the said material is protected from the direct contact with the thermal head by the thermo resistant separating film, that is stored on a reel, whereas the said tool -is provided with a locker to fasten stiffly the free end of the said separating film, the said reel is placed in the direction where the thermal head moves when performing the processing of the surface of the said material (the rear direction) and the said locker is placed in the direction where the said thermal head starts its movement (the front direction), and a friction element is used that prevents free rotation of the said roller and unwinding of the said separating film, and an elastic element is used that holds the part of the said separating film between the thermal head and reel under tension.

12. Blank stamp, provided with disposable separating film and appliances for fastening, characterized in that when placed into the tool for fastening of blank stamp into the apparatus for manufacturing of the stamps by use of thermal head, the said tool fastens stiffly that end of the said separating film where the sliding of the thermal head over the surface of the blank stamp starts (front end), whereas in the opposite end (rear end) elastic tension is created and the said elastic tension of the said separating film and its fastening elements when the blank stamp is placed in the said tool is higher than the elastic tension of the same elements when lying freely or packed.
